(19) United States
(12) Patent Application Publication
(10) Pub. No.: US 2006/0202958 A1
(43) Pub. Date: Sep. 14, 2006

(54) Queue management and state record display device for a computer mouse

(76) Inventor: Yuan-Jung Chang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/073,664

(22) Filed: Mar. 8, 2005

(51) Int. Cl. G09G 5/08

(52) U.S. Cl. 345/163

(57) ABSTRACT

A queue management and state display device of a computer mouse is described. The computer mouse has an image queue management unit and a function state record unit. Shifting the computer mouse is increasingly smooth due to the image queue management unit, and the function state record unit displays the present function state of computer mouse by the display unit.

### BACKGROUND OF THE INVENTION

1. Field of the Invention

The present invention generally relates to an queue management and state display device for a computer mouse, and more particularly, a queue management that produces and controls a shifting data flow for smooth shifting of the computer mouse, and a state display device that displays the present function state of the computer mouse.

2. Description of Related Art

A standard computer mouse uses RS-232, PS/2 and wireless transmission and is very functional. However, if the computer mouse only provides basic functions and does not evolve, it will not keep pace with the general trend for peripherals to provide more advanced functions. This is thus the design goal of the industry, with recognition that the mouse is an important tool for computer use.

Many versions of the mouse are available on the market, such as, a bluetooth wireless mouse, an ergonomic mouse and a wireless mouse for generating electric power. These designs do not, however, provide smooth shifting and function state display.

### SUMMARY OF THE INVENTION

An object of the present invention is to provide a queue management and function state display device for a computer mouse. The queue management produces and controls a shifting data flow for smooth shifting of the computer mouse, and a display unit displays the function state of the computer mouse.

To fulfill the above objective, a queue management and function state display device for a computer mouse includes a universal bus control unit, a wire mouse microprocessor, a sense image processor, a button unit, a wheel unit and a display unit. The wire mouse microprocessor includes an image data processing unit, a data shifting process unit, a function state record unit and an image queue management unit. The wire mouse processor is electrically connected to the universal bus control unit. The sense image processor, the button unit, the wheel unit and the display unit all electrically connect to the wire mouse microprocessor. The button unit starts the image queue management unit with the function state record unit, the image queue management unit operates to produce the shifting data of the image data processing unit, the data shifting process unit and then to control a flow of the shifting data. The function state record unit displays the function state of computer mouse on the display unit.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a queue management and state display device for a wire mouse according to the present invention; and

FIG. 2 is a queue management and state display device for a wireless mouse according to the present invention.

### DETAILED DESCRIPTION OF THE EMBODIMENTS

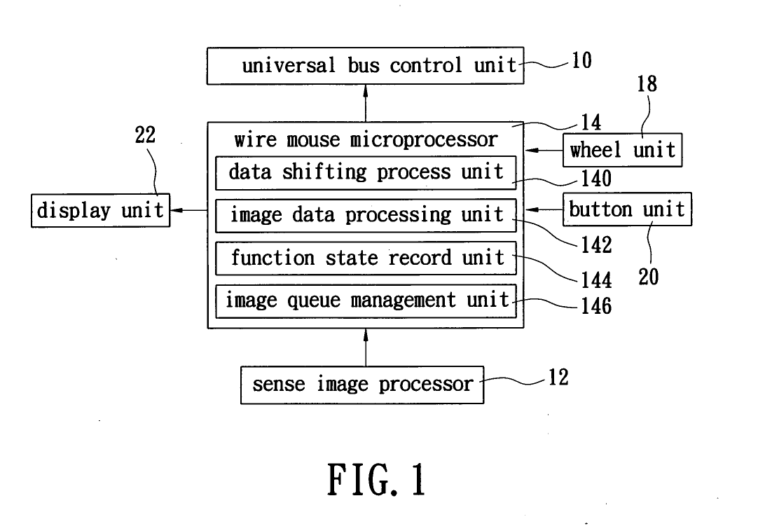

Referring to FIG. 1, a queue management and state display device for a wire mouse of the present invention is illustrated, comprising a universal bus control unit 10, a sense image processor 12, a wire mouse microprocessor 14, a wheel unit 18, a button unit 20, a display unit 22. The universal bus control unit 10 is electrically connected to the wire mouse microprocessor 14, and the wire mouse microprocessor 14 conveys a signal to computer host by the universal bus control unit 10. The wire mouse microprocessor 14 includes a data shifting process unit 140, an image data processing unit 142, a function state record unit 144 and an image queue management unit 146. The sense image processor 12 is electrically connected to the wire mouse microprocessor 14, and the wheel unit 18, the button unit 20 and the display unit 22 are all electrically connected to the wire mouse microprocessor 14. The display unit 22 is an LED.

The button unit 20 starts the image queue management unit 146 with the function state record unit 144, the image queue management unit 146 operates to produce the shifting data of the image data processing unit 142, the data shifting process unit 140 and then controls the flow of the shifting data, and the function state record unit 144 displays the function state of wire mouse by the display unit 22.

When operating the queue management and state display device for a wire mouse, the button unit 20 is touched, which conveys a signal with a signal of the sense image processor 12 to the image data processing unit 142 and the function state record unit 144. The image data processing unit 142 conveys plural signals to the data shifting process unit 140 with which to collect shifting data of the wire mouse. These signals are arrayed to the queue manage unit 146 for controlling transmission rate of the shifting data flow between the wireless mouse and the computer host, so the queue manage unit 146 solves not only the delay problem but also smoothes the wire mouse shifting. Another wire mouse microprocessor 14 records the mouse state by the function state record unit 144 and informs a user of the present mouse state by the display unit 22; for example, on the first push of the button unit 20, the display unit 22 displays a red light for a high speed state. On the second push of the button unit 20, the display unit 22 is turned off for a low speed state. A third push of the button unit 20 turns on the display unit 22 for a play state, which is when the operating button of wire mouse transfers the hot-key.

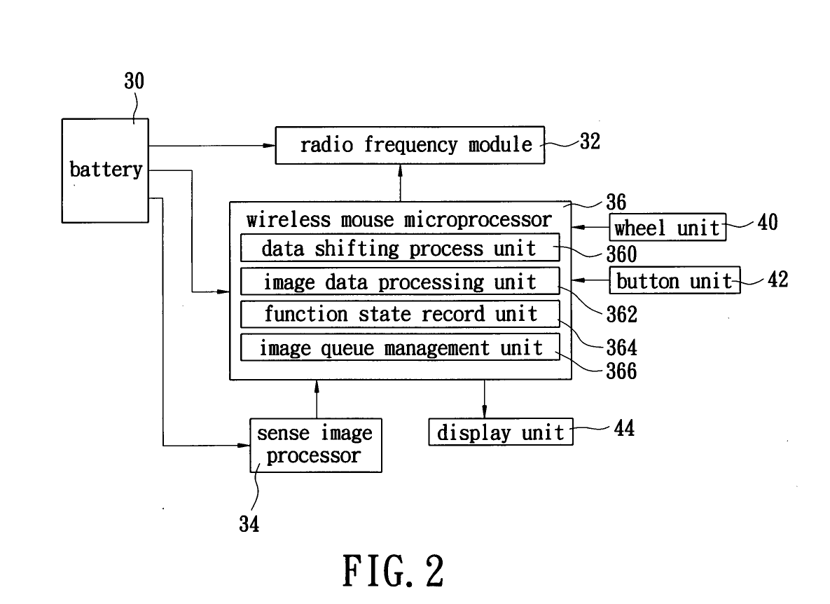

Referring to FIG. 2; an queue management and state display device for a wireless mouse of the present invention is illustrated, comprising a radio frequency module 32, a sense image processor 34, a wireless mouse microprocessor 36, a wheel unit 40, a button unit 42, a display unit 44 and a battery 30. The radio frequency module 32 is electrically connected to the wireless mouse microprocessor 14, which outputs a packet of wireless mouse processor 36 to a computer host by a wireless access protocol. The wireless mouse microprocessor 36 includes a data shifting process unit 360, an image data processing unit 362, a function state record unit 364 and an image queue management unit 366. The sense image processor 34 is electrically connected to the wire mouse microprocessor 36, and the wheel unit 40, the button unit 42 and the display unit 44 are all electrically connected to the wireless mouse microprocessor 36. The battery 30 provides power to the radio frequency module 32, the sense image process 34 and the wireless mouse microprocessor 36. The display unit 44 is an LED.

The button unit 42 starts the image queue management unit 366 with the function state record unit 364, the image queue management unit 366 operates to produce the shifting data of the image data processing unit 362, the data shifting process unit 360 and then controls the flow of the shifting data, and the function state record unit 364 displays the function state of wire mouse on the display unit 44.

When operating the queue management and state display device for a wireless mouse, when the button unit 42 is touched, a signal with a signal of the sense image processor 34 is conveyed to the image data processing unit 362 and the function state record unit 364. The image data processing unit 362 conveys plural signals to the data shifting process unit 360 with which to collect shifting data of the wireless mouse, and these signals are arrayed to the queue manage unit 366 for controlling transmission rate of the shifting data flow between the wireless mouse and the computer host. The queue manage unit 366 thus solves not only the delay problem but also smoothes the wireless mouse shifting. Another the wireless mouse microprocessor 36 records the mouse state by the function state record unit 362 and informs a user of the present mouse state by the display unit 44; for example, on a first push of the button unit 42, the display unit 44 displays a red light for a high speed state. A second push of the button unit 42 turns off the display unit 44 for a low speed state. A third push of the button unit 42 turns on the display unit 44 for a play state, which is when the operating button of the wireless mouse transfers the hot-key.

To sum up, the present invention has the following characteristics:

1. A queue management and state display device for a computer mouse provides smooth shifting of a computer mouse.

2. A queue management and state display device for a computer mouse display the present function state of computer mouse.

What is claimed is:

1. A queue management and state record display device for a computer mouse, comprising:
a universal bus control unit;
a wire mouse microprocessor including an image data processing unit, a data shifting process unit, a function state record unit and an image queue management unit, wherein the wire mouse processor electrically connects to the universal bus control unit;
a sense image processor electrically connected to the wire mouse microprocessor;
a button unit electrically connected to the wire mouse microprocessor; and
a display unit electrically connected to the wire mouse microprocessor;
wherein the button unit is provided for starting the image queue management unit and the function state record unit, the image queue management unit is operated to produce shifting data of the image data processing unit, the data shifting process unit and then to control a flow of the shifting data, and the function state record unit displaying a function state of computer mouse on the display-unit.

2. The queue management and state record display device of claim 1, further comprising a wheel unit electrically connected to the wire mouse microprocessor.

3. The queue management and state record display device of claim 1, wherein the display unit is an LED.

4. A queue management and state record display device for a computer mouse, comprising:
a radio frequency module;
a wireless mouse microprocessor including a image data processing unit, a data shifting process unit, a function state record unit and an image queue management unit, the wireless mouse processor being electrically connected to the radio frequency module so that the radio frequency is for outputting a packet of the wireless mouse processor to a computer host by a wireless access protocol;
a sense image processor electrically connected to the wireless mouse microprocessor;
a button unit electrically connected to the wireless mouse microprocessor; and
a display unit electrically connected to the wireless mouse microprocessor;
wherein the button unit is provided for starting the image queue management unit with the function state record unit, the image queue management unit operates to produce shifting data of the image data processing unit, the data shifting process unit and then control a flow of the shifting data, and the function state record unit displays a function state of computer mouse with the display unit.

5. The queue management and state record display device of claim 4, further comprising a wheel unit electrically connected to the wireless mouse microprocessor.

6. The queue management method and state display device of claim 4, further comprising a battery for providing the radio frequency module, the sense image processor and the wireless mouse microprocessor with electric power.

7. The queue management and state record display device of claim 4, wherein the display unit is an LED.
